(19) United States
(12) Patent Application Publication
(10) Pub. No.: US 2011/0232779 A1
(43) Pub. Date: Sep. 29, 2011

(54) Excess flow safety shut-off valve

(76) Inventor: Seung-il Oh, Seoul (KR)

(21) Appl. No.: 12/659,879

(22) Filed: Mar. 24, 2010

(51) Int. Cl. F16K 17/20

(52) U.S. Cl. 137/485

(57) ABSTRACT

The present invention relates to an excess flow safety shut-off valve including: a cylindrical body having an outlet and a mounting part formed at one side thereof and a plurality of guides formed in the mounting part in such a manner as to be protruded inwardly from the outlet; an inlet cap disposed at the opposite side to the outlet in such a manner as to be assembled with the cylindrical body; and a ball member adapted to be supportedly mounted in the mounting part by means of the plurality of guides in such a manner as to be attached to the protruding part of the inlet cap by means of a magnetic force generated from the magnet and adapted to be detached from the protruding part to block the outlet if excess water flow occurs.

### BACKGROUND OF THE INVENTION

1. Field of the Invention

The present invention relates to an excess flow safety shut-off valve that is configured to automatically block an inlet when a water supply and draining piping system is cut or damaged, thereby preventing excess water flow from occurring therein.

2. Background of the Related Art

FIG. 1 shows a conventional excess flow safety shut-off valve, which is disclosed in U.S. Pat. No. 7,111,638. As shown, the excess flow safety shut-off valve includes: a shut-off sleeve 2 adapted to be movable toward an inlet by means of increasing water flow through a body 1 after a pipe has been cut; a shut-off member 3 adapted to prevent the movement of the shut-off sleeve 2 toward an outlet side; a spring 4 disposed between the shut-off sleeve 2 and the shut-off member 3; and a flexible bladder 5 disposed in the body 1 for enclosing and surrounding the spring 4 in such a manner as to be pressed against the shut-off sleeve 2.

According to the above-mentioned conventional excess flow safety shut-off valve, the shut-off sleeve 2 is moved to operate the shut-off member 3 if the pipe is cut to cause water flow to be increased, thereby blocking flowing water therefrom. While the flexible bladder 5 provides a time delay during which there is no movement of the shut-off sleeve 2, water is unavoidably leaked to the outside through the damaged portion of the pipe. Furthermore, the conventional excess flow safety shut-off valve is provided with extended portions 6 and 7 formed at the both sides of the body 1 for mating with the both sides of the pipe, which undesirably giving many restrictions in its usable conditions.

After the experiment on the control of the water flow for the conventional excess flow safety shut-off valve as disclosed above is performed by the same applicant as the prevent invention, moreover, it is found that noise is made when the shut-off sleeve 2 is a number of times moved forwardly and backwardly at its limit point, which may cause large uncontrolled water quantity at the limit point from being leaked through the damaged pipe to the outside.

According to the conventional excess flow safety shut-off valve, additionally, so as to restore the shut-off sleeve 2 from the closed position to the opened position, the extended portions 6 and 7 extended from the both sides of the body 1 should be inconveniently separated from the pipe, and moreover, if a predetermined period of time during which aging of the pipe is caused passes by, the durability of the safety shut-off valve may be decreased to fail to obtain given effects through the safety shut-off valve.

### SUMMARY OF THE INVENTION

Accordingly, the present invention has been made in view of the above-mentioned problems occurring in the prior art, and it is an object of the present invention to provide an excess flow safety shut-off valve that has a ball member adapted to be attachable to a magnet, in normal cases, and adapted to be detachable from the magnet to rapidly block an outlet, if excess flow occurs by the cut-off of a pipe, and if a connector between the pipe and the valve is deviated from its fixed position.

It is another object of the present invention to provide an excess flow safety shut-off valve that is configured to allow all of parts to be mounted in a simple manner inside a cylindrical body, thereby being applicable to all products having a space portion into which the cylindrical body is inserted.

To accomplish the above objects, according to the present invention, there is provided an excess flow safety shut-off valve including: a cylindrical body having an outlet and a mounting part formed at one side thereof and a plurality of guides formed in the mounting part in such a manner as to be protruded inwardly from the outlet; an inlet cap disposed at the opposite side to the outlet in such a manner as to be coupled to the cylindrical body and having a flange part formed along the outer periphery thereof, a protruding part extended inwardly from the center portion thereof, a plurality of connection pieces adapted to integrally connect the flange part and the protruding part to each other, a plurality of inlet passages formed between the flange part and the protruding part by the integral connection between the flange part and the protruding part, and a magnet embedded inside the protruding part; and a ball member adapted to be supportedly mounted in the mounting part by means of the plurality of guides in such a manner as to be attached to the protruding part of the inlet cap by means of a magnetic force generated from the magnet and adapted to be detached from the protruding part to block the outlet if excess water flow occurs.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional excess flow safety shut-off valve;

FIG. 2 is an exploded perspective view showing an excess flow safety shut-off valve according to the present invention;

FIG. 3 is a sectional view showing the assembled state of the excess flow safety shut-off valve of the present invention;

FIG. 4 is a sectional view showing the state wherein an outlet is blocked in the excess flow safety shut-off valve of the present invention;

FIG. 5 is a sectional view taken along the line X-X of FIG. 4;

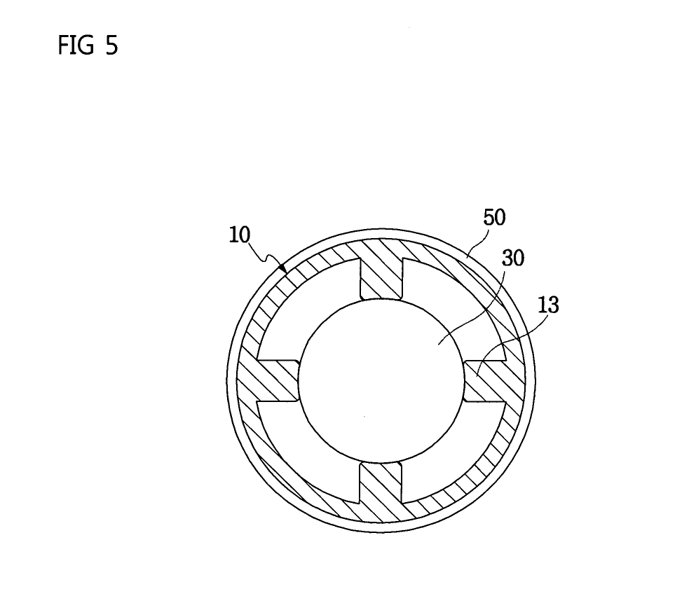

FIG. 6 is a side view showing an inlet cap of the excess flow safety shut-off valve of the present invention;

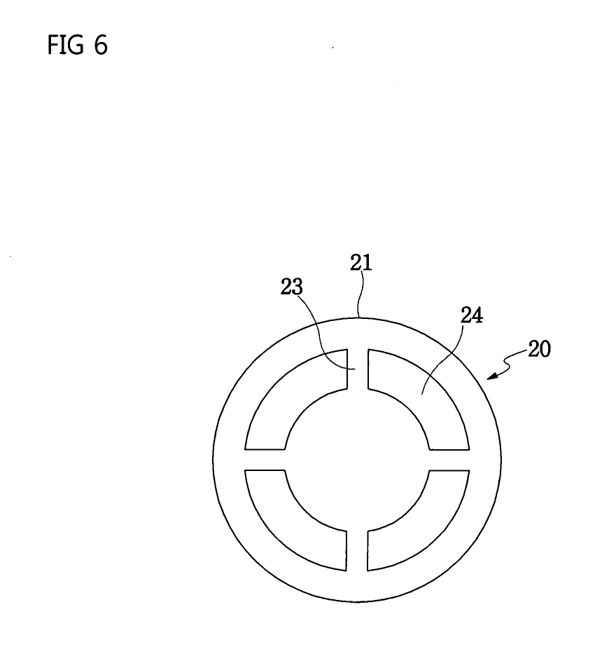

FIG. 7 is a sectional view showing the state wherein the excess flow safety shut-off valve of the present invention is mounted to a connector; and

FIG. 8 is a sectional view showing the state wherein the excess flow safety shut-off valve of the present invention is mounted to a valve body.

### DETAILED DESCRIPTION OF THE PREFERRED EMBODIMENT

Hereinafter, an explanation on an excess flow safety shut-off valve according to the present invention will be in detail given with reference to the attached drawings.

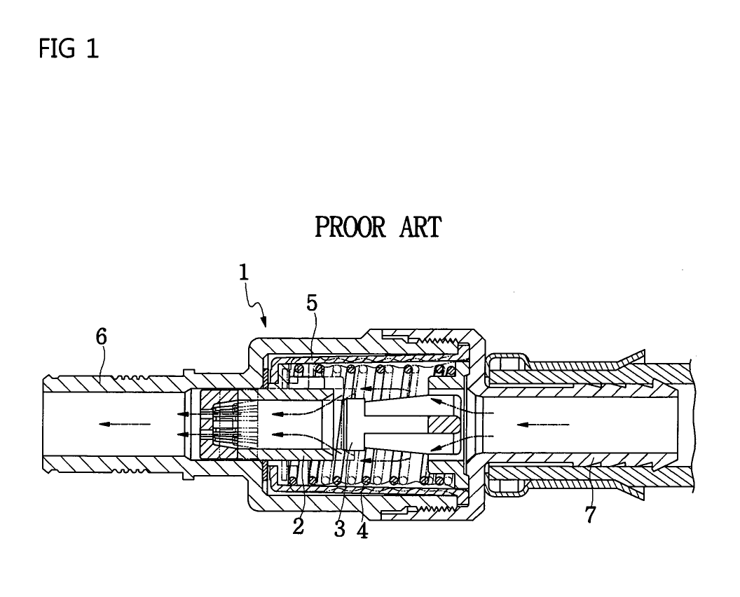

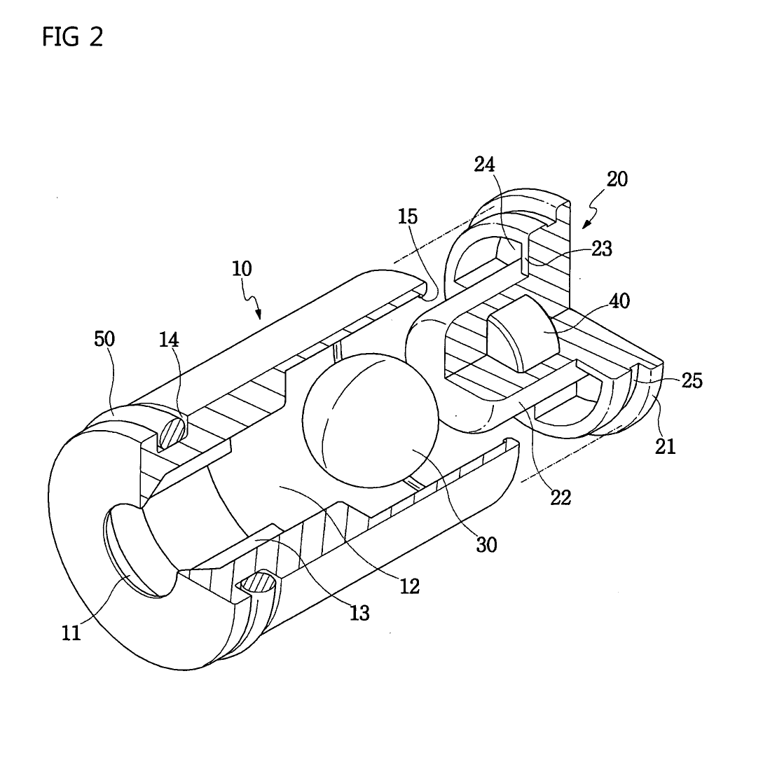

As shown in FIGS. 1 and 2, an excess flow safety shut-off valve according to the present invention largely includes a cylindrical body 10, an inlet cap 20, and a ball member 30.

The cylindrical body 10 has an outlet 11 formed at one side thereof, the outlet 11 being adapted to be opened and closed by means of the ball member 30, a mounting part 12 formed extended from the outlet 11, and a plurality of guides 13 protruded inwardly from the outer wall periphery of the outlet 11 inside the mounting part 12 in such a manner as to be spaced apart from each other, the plurality of guides 13 serving to fixedly support the ball member 30 to be mounted in the mounting part 12.

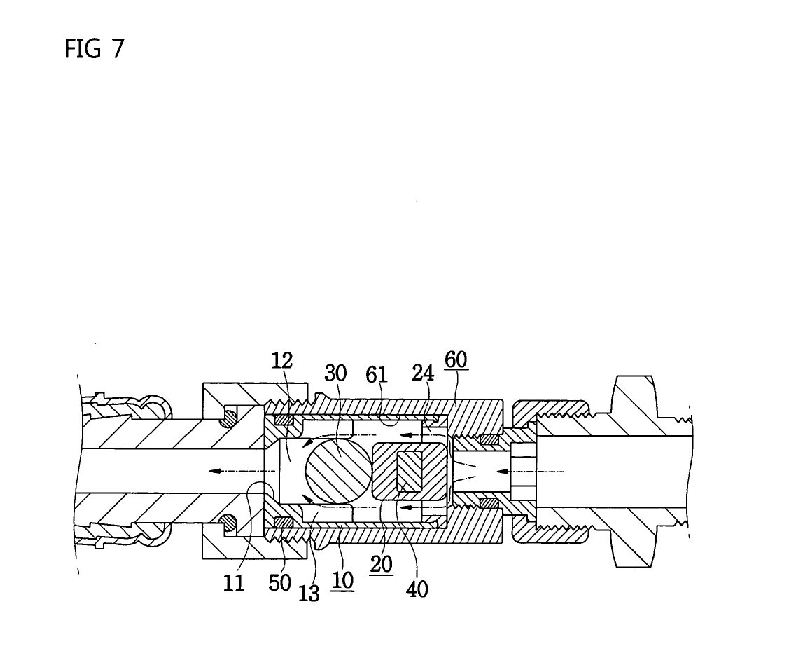

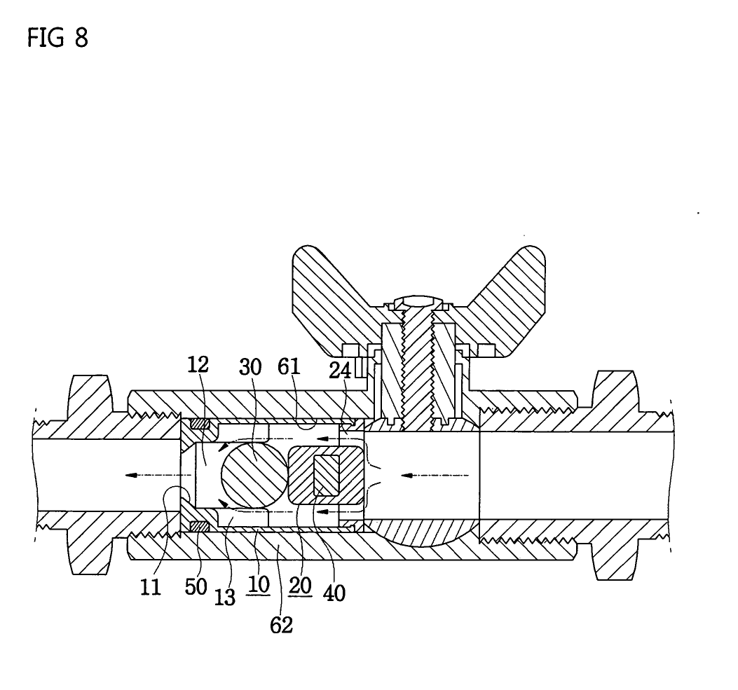

The outlet 11 has a packing groove 14 formed along the outer periphery thereof and a ring-shaped packing 50 insertedly disposed along the packing groove 14, thereby desirably maintaining air tightness around a connector 60 or an insertion hole 61 formed along a valve body 62, into which the cylindrical body 10 is inserted (See FIGS. 7 and 8).

The inlet cap 20 has a flange part 21 formed along the outer periphery thereof, a protruding part 22 formed inwardly from the center portion thereof, a plurality of connection pieces 23 adapted to integrally connect the flange part 21 and the protruding part 22 to each other, and a plurality of inlet passages 24 formed between the flange part 21 and the protruding part 22 by the integral connection between the flange part 21 and the protruding part 22. The protruding part 22 is extended protrudedly from the flange part 21 and has a magnet 40 embedded therein, the magnet 40 applying a magnetic force to a forward direction. The protruding part 22 serves to protect the magnet 40 from the damages caused by water flow.

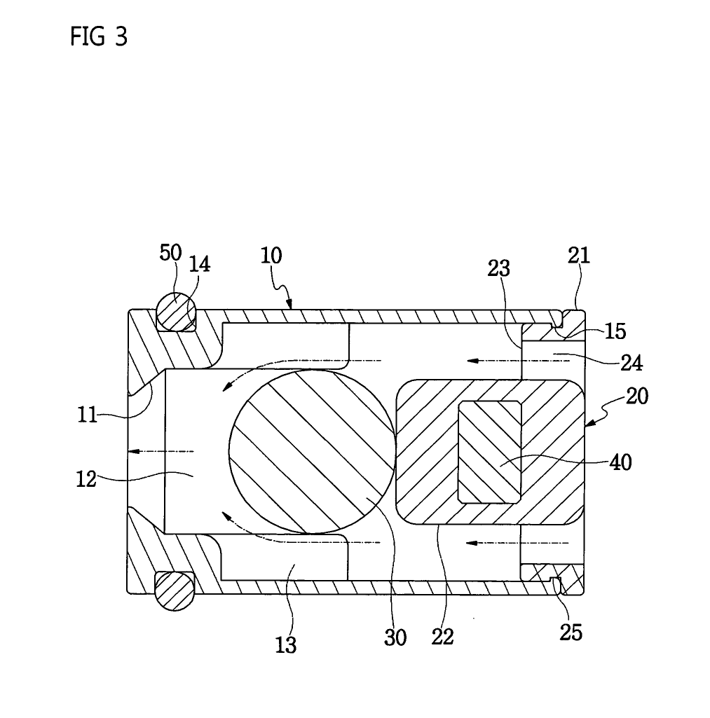

The flange part 21 of the inlet cap 20 is coupled to the inlet side of the cylindrical body 10, such that the protruding part 22 is disposed inside the mounting part 12. In more detail, as shown in FIGS. 2 and 3, the flange part 21 has a groove 25 formed along the outer periphery thereof and the cylindrical body 10 has a projection 15 formed along the inlet side thereof to correspond to the groove 25 of the flange part 21. The coupling configuration between the cylindrical body 10 and the flange part 21 of the inlet cap 20 is not limited to the formation of the groove 25 and the projection 15, and a variety of known coupling ways may be adopted. For example, screw fastening is allowed by the formation of screw holes on the inlet side of the mounting part 12 and screws on the flange part 21.

The distance from the end portion of the protruding part 22 to the inlet 11 is set longer than the distance within which the magnetic force generated from the magnet 40 is applied to the ball member 30, and desirably, the distance from the end portion of the protruding part 22 to the inlet 11 is set such that only if the magnet 40 is slightly pushed through the outlet 11, the ball member 30 is just attached to the protruding part 22 by means of the magnetic force generated by the magnet 40 embedded in the protruding part 22.

According to the present invention, the ball member 30 is put into the mounting part 12 of the cylindrical body 10, and the inlet cap 20 is coupled to the cylindrical body 10. So as to make the ball member 30 attached to the protruding part 22, then, the cylindrical body 10 is somewhat slant, and alternatively, the ball member 30 is just pushed through the outlet 11. As a result, the assembling processes of all parts are all finished, which advantageously provides simplified configuration of the product.

The cylindrical body 10 into which the ball member 30 is attached to the protruding part 22 is inserted into the connector 60 or the insertion hole 61 of the valve body 62. Next, a pipe is mounted to connect the outlet 11 to a water supply and draining system such as a faucet, a shower head, and the like.

In normal cases, generally, the flow rate of water flowing through the cylindrical body 10 and the water supply and draining system is under 2.5 gallons per minute, and at this time, the water generally enters the mounting part 12 through the inlet passages 24 and flows around the ball member 30. Next, when the water is discharged through the outlet 11, the force pulling the ball member 30 is caused from the outlet 11. At the water flow rate of under 2.5 gallons per minute, however, since the magnetic force of the magnet 40 embedded inside the protruding part 22 is larger than the force of the outlet 11 pulling the ball member 30, the ball member 30 is maintained at the attached state to the protruding part 22.

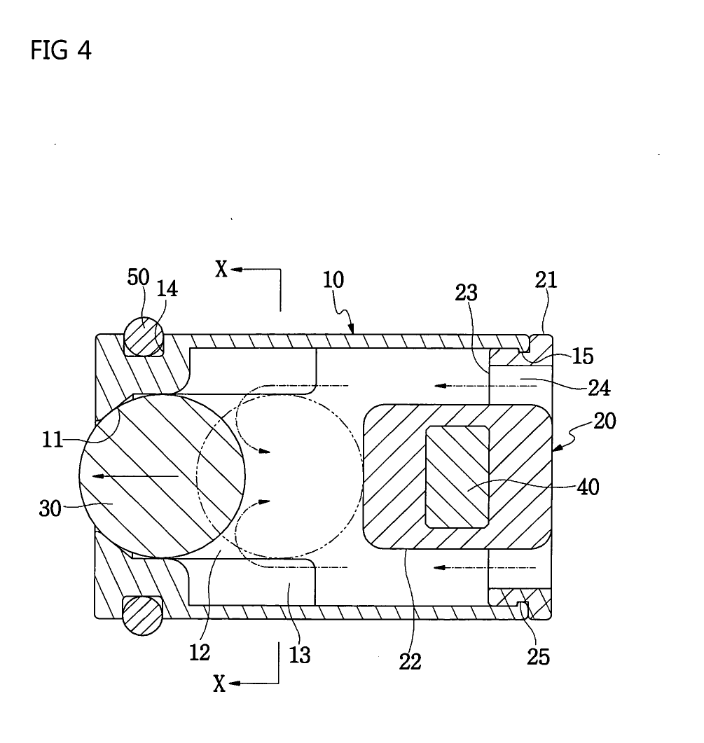

If the pipe of the water supply and draining system is damaged and cut, and alternatively, if the connector between the valve and the pipe escapes from its fixed position, the flow rate controlled by the water supply and draining system is drastically increased. Thus, the force pulling the ball member 30 from the outlet 11 side is larger than the magnetic force generated from the magnet 40, so that the ball member 30 is detached from the protruding part 22 and at the same time blocks the outlet 11, as shown in FIG. 4.

At the moment where the flow rate excessively increases through the pipe cut by its aging or through the pipe from which the connector escapes, the ball member 30 serves to block the outlet 11, which prevents the water flowing into the pipe from being discharged to the outside, thereby previously avoiding the damages like flooding.

After the cut pipe is exchanged into new one or the connector is disposed again, the ball member 30 just pushes through the outlet 11 to a range where the magnetic force of the magnet 40 is applied, thereby being attached to the protruding part 22. As a result, the safety shut-off valve of the present invention is returned to its normal state.

FIG. 7 shows the state wherein the safety shut-off valve of the present invention is inserted into the insertion hole 61 of the connector 60, thereby connecting the safety shut-off valve to the pipe through fastening parts formed at the both sides of the connector 60. FIG. 8 shows the state wherein the safety shut-off valve of the present invention is inserted into the insertion hole 61 of the valve body 62.

In other words, the excess flow safety shut-off valve according to the present invention is of a generally cylindrical shape, and therefore, only if the water supply and draining system has the insertion hole, the safety shut-off valve can be freely installed, thereby achieving the desired objects according to the present invention.

As described above, if excess flow occurs by the cut-off of the pipe or the deviation of the connector from the pipe, the ball member 30 that is in an opened position by means of the magnetic force generated from the magnet 40 instantly blocks the outlet 11, thereby preventing the damages like flooding. Additionally, since all parts of the excess flow safety shut-off valve according to the present invention are disposed inside the cylindrical body, the excess flow safety shut-off valve can be applied to all products each having the insertion hole into which the cylindrical body is inserted.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An excess flow safety shut-off valve comprising:
a cylindrical body having an outlet and a mounting part formed at one side thereof and a plurality of guides formed in the mounting part in such a manner as to be protruded inwardly from the outlet;
an inlet cap disposed at the opposite side to the outlet in such a manner as to be coupled to the cylindrical body and having a flange part formed along the outer periphery thereof, a protruding part extended inwardly from the center portion thereof, a plurality of connection pieces adapted to integrally connect the flange part and the protruding part to each other, a plurality of inlet passages formed between the flange part and the protruding part by the integral connection between the flange part and the protruding part, and a magnet embedded inside the protruding part; and
a ball member adapted to be supportedly mounted in the mounting part by means of the plurality of guides in such a manner as to be attached to the protruding part of the inlet cap by means of a magnetic force generated from the magnet and adapted to be detached from the protruding part to block the outlet if excess water flow occurs.

2. The excess flow safety shut-off valve according to claim 1, wherein the outlet has a packing groove formed along the outer periphery thereof, the packing groove having a packing disposed therealong.

3. The excess flow safety shut-off valve according to claim 1, wherein the flange part of the inlet cap has a groove formed along the outer periphery thereof, and the cylindrical body has a projection formed along the inlet side thereof to correspond to the groove of the flange part.

4. The excess flow safety shut-off valve according to claim 1, wherein the cylindrical body and the inlet cap are screw-coupled to each other.
